(19) United States
(12) Patent Application Publication
(10) Pub. No.: US 2024/0311677 A1
(43) Pub. Date: Sep. 19, 2024

(54) DATA CLASSIFICATION METHOD FEASIBLE ON NISQ COMPUTER AND APPARATUS THEREOF

(71) Applicant: KOREA ADVANCED INSTITUTE OF SCIENCE AND TECHNOLOGY, Daejeon (KR)

(72) Inventors: June-Koo RHEE, Daejeon (KR); Siheon PARK, Daejeon (KR); Kyungdeock PARK, Daejeon (KR)

(21) Appl. No.: 18/575,259

(22) PCT Filed: Jun. 27, 2022
(86) PCT No.: PCT/KR2022/009122

§ 371 Date: Dec. 28, 2023

(30) Foreign Application Priority Data
Jun. 29, 2021 (KR) 10-2021-0085089

(51) Int. Cl. G06N 10/60; G06N 20/10

(52) U.S. Cl. CPC G06N 10/60; G06N 20/10

(57) ABSTRACT

The present invention relates to a data classification apparatus feasible on an NISQ computer, comprising: a weight calculation unit that calculates weight information that minimizes an objective function of a quantum approximation support vector machine (QASVM) algorithm; and a data classification unit that calculates a classification score of the QASVM algorithm using the weight information obtained from the weight calculation unit, and classifies a class of input data on the basis of the calculated classification score.

### TECHNICAL FIELD

The disclosure relates to a method and an apparatus for classifying data and, more specifically, to a method for classifying data by using a quantum machine learning algorithm feasible on a noise intermediate scale quantum (NISQ) computer, and an apparatus thereof.

### BACKGROUND ART

Machine learning is a field related to various methods that enable machines to implement problem-solving capabilities through learning. Learning of a program or algorithm refers to enhancing performance through experience, and obtains the effect of computer learning by changing internal variables appropriately based on the results of analyzing given data. As the amount of data increases, the effect and utility of machine learning increases, but the scalability of machine learning algorithms for large-scale data becomes an issue. Existing machine learning techniques are increasingly important due to the emergence of explosively increasing big data, but they do not have the scalability to process big data and suffer issues such as delays in processing speed due to big data, and thus various methods such as parallel processing research are being explored. In other words, since the performance of machine learning is based on the performance of classical (current) computers, classical computers reach the limit of technological growth, and thus machine learning is also facing the limit of technological growth. Accordingly, interest in quantum computers to replace classical computers is gradually increasing.

A quantum computer is a computer of a new concept that can simultaneously process multiple pieces of information by using the unique physical characteristics of a quantum, such as superposition and entanglement. Quantum computers are increasingly needed as an alternative to overcome the performance limitations of classical computers due to leakage currents generated from microcircuits of modern semiconductor chips. Quantum computers can solve problems at a high speed by exponentially increasing information processing and computation speeds through quantum parallel processing that uses quantum bits or qubits, which are quantum information units, as the basic unit of information processing. Accordingly, quantum computers have strengths in complex calculations and mass data processing, such as optimal path search, prime factorization, and mass data search, and are expected to bring huge innovations to various industries such as finance, chemistry, and pharmaceuticals.

Meanwhile, quantum machine learning (QML), obtained by incorporating machine learning and quantum computers, is receiving a lot of attention for its attempts to bring about revolutionary changes to the field of machine learning in the big data era. Currently, approaches to quantum machine learning (QML) may be divided into two main categories. One is an approach that derives exponential speed improvement in vector-related computations by utilizing various quantum gates and applies the same to various existing machine learning algorithms, resulting in exponential speed improvement compared to classical machine learning algorithms. This approach assumes the existence of a general-purpose quantum computer and focuses on algorithms, and is currently expected to take a considerable amount of time for practical implementation. On the other hand, the other approach is a method of obtaining a basis value of a desired Hamiltonian function by using a quantum adiabatic theorem to solve a difficult optimization problem. Although this approach has several advantages in hardware implementation, there are still unsolved issues regarding the expected increase in calculation speed.

A representative quantum machine learning (QML) algorithm having the former approach is a quantum support vector machine (QSVM). The quantum support vector machine (QSVM) is a quantum supervised learning algorithm that incorporates quantum theory into the classical support vector machine (SVM), and was first proposed through a paper (Quantum Support Vector Machine For Big Data Classification) contributed by an MIT laboratory in 2014 and has been theoretically demonstrated to provide exponential speed-up over classical machine learning algorithms.

However, since the quantum support vector machine (QSVM) relies on comprehensive subroutines such as density matrix exponential and quantum matrix inversion, there is a problem that the QSVM is unable to be run on NISQ computers expected to be available in the near future. In other words, the quantum support vector machine (QSVM) can be run by a full-fledged quantum computer, but there is great uncertainty as to when the full-fledged quantum computer would to be implemented in future.

Recently, a Hadamard-test classifier (HTC) and swap-test classifier (STC) have been developed as alternatives to the quantum support vector machine (QSVM). Since the HTC/STC classifiers do not require density matrix exponentials and quantum matrix inversions, they have the advantage of being more feasible than the quantum support vector machine (QSVM). However, the HTC/STC classifiers use all of data having some fixed weight factors without the need to perform an optimization process to find a separating hyperplane. As a result, the HTC/STC classifiers suffer from poor classification performance compared to the quantum support vector machine (QSVM). Therefore, there is a need to develop a quantum machine learning algorithm that is feasible on the NISQ computer and has excellent classification performance.

### DISCLOSURE OF INVENTION

### Technical Problem

The disclosure is to solve the foregoing and other problems. Further, the disclosure is to provide a method and an apparatus for implementing a quantum approximate support vector machine (QASVM) algorithm that approximates an optimization problem of a support vector machine for NISQ applications.

In addition, the disclosure is to provide a method and an apparatus for classifying data by using a quantum approximate support vector machine (QASVM) algorithm feasible on a NISQ computer.

### Solution to Problem

According to an aspect of the disclosure, there is provided a data classification apparatus feasible on a NISQ computer, the apparatus including a weight calculation unit configured to calculate weight information for minimizing an objective function of a quantum approximate support vector machine (QASVM) algorithm, and a data classification unit configured to calculate a classification score of the QASVM algorithm using the weight information obtained from the weight calculation unit, and classify a class of input data based on the calculated classification score.

According to another aspect of the disclosure, there is provided a data classification method feasible on a NISQ computer, the method including calculating weight information for minimizing an objective function of a quantum approximate support vector machine (QASVM) algorithm, calculating a classification score of the QASVM algorithm using the calculated weight information, and classifying a class of input data based on the calculated classification score.

### Advantageous Effects of Invention

The effects of a data classification method and an apparatus thereof according to embodiments of the disclosure are described as follows.

According to at least one of the embodiments of the disclosure, a data classification function that is feasible on a NISQ computer and has excellent classification performance can be performed using a quantum approximate support vector machine (QASVM) that approximates the optimization problem of a classical support vector machine.

In addition, according to at least one of the embodiments of the disclosure, a data classification function that is feasible on a NISQ computer and has excellent classification performance can be performed, by calculating an objective function and a classification score of an optimization problem using a quantum circuit, and updating the parameters of the objective function using a classical heuristic optimization technique.

However, the effects that can be achieved by the data classification method and the apparatus according to the embodiments of the disclosure are not limited to those mentioned above, and other effects not mentioned above can be clearly understood by those skilled in the art in the technical field to which the disclosure belongs, from the description below.

### BRIEF DESCRIPTION OF DRAWINGS

FIGS. 1A to 1D are diagrams referenced to explain a support vector machine (SVM) algorithm related to the disclosure;

FIG. 2 illustrates the structure of a swap test classifier (STC) related to the disclosure;

FIGS. 3 and 4 illustrate quantum circuits for calculating an objective function of a QASVM algorithm according to an embodiment of the disclosure;

FIG. 5 illustrates a quantum circuit for calculating a classification score of a QASVM algorithm according to an embodiment of the disclosure;

FIG. 6 illustrates a configuration of a data classification apparatus according to an embodiment of the disclosure; and

FIG. 7 is a configuration block diagram of a computing device according to an embodiment of the disclosure.

### BEST MODE FOR CARRYING OUT THE INVENTION

Hereinafter, exemplary embodiments disclosed herein will be described in detail with reference to the accompanying drawings, but the same or similar elements will be assigned the same reference numbers regardless of the reference numerals, and redundant descriptions thereof will be omitted. The suffixes “module” and “unit” for elements used in the following description are given or mixed in consideration of the case of writing the specification, and do not have meanings or roles that are distinct from each other. That is, the term “unit” used in the disclosure refers to a software component or a hardware component such as FPGA or ASIC, and the “unit” performs a certain role. However, the “unit” is not limited to software or hardware. The “unit” may be configured to be in an addressable storage medium, or may be configured to reproduce one or more processors. Accordingly, as an example, the “unit” includes components such as software components, object-oriented software components, class components, and task components, processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Further, in describing the embodiments disclosed herein, if it is determined that a detailed description of the related prior art would obscure the essence of the embodiments disclosed herein, the detailed description is omitted. In addition, the accompanying drawings are intended only to facilitate understanding of the embodiments disclosed herein, and it should be understood that the technical ideas disclosed herein are not limited by the accompanying drawings and include all modifications, equivalents, or substitutions that are within the scope of the ideas and technology of the disclosure.

The disclosure proposes a method and an apparatus for implementing a quantum approximate support vector machine (QASVM) that approximates an optimization problem of a support vector machine for NISQ applications. In addition, the disclosure proposes a method and an apparatus for classifying data using a quantum approximate support vector machine (QASVM) algorithm feasible on a NISQ computer.

Hereinafter, various embodiments of the disclosure will be described in detail with reference to the drawings.

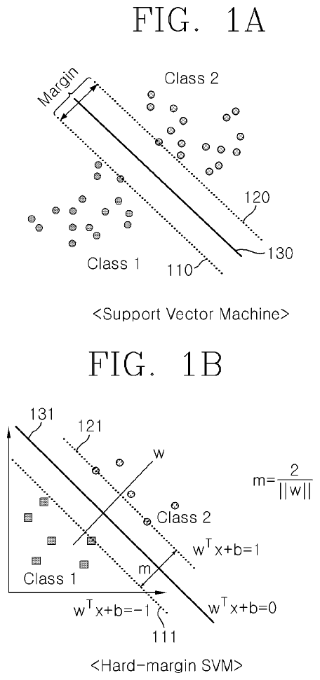

FIGS. 1A to 1D are diagrams referenced to explain a support vector machine (SVM) algorithm related to the disclosure.

Referring to FIGS. 1A to 1D, a support vector machine (SVM) related to the disclosure is a supervised learning model for pattern recognition and data analysis as one of the fields of machine learning, and is mainly used for classification and regression analysis.

Given a data set belonging to one of two classes, the SVM algorithm generates a binary linear classification model that determines a class to which new data belongs, based on the given data set. The binary linear classification model is expressed as a decision boundary in a space where data is mapped, and the SVM algorithm is an algorithm that finds a decision boundary having the largest width.

For example, as shown in FIG. 1A, the SVM algorithm is an algorithm of finding a decision boundary (i.e., a hyperplane 130) that maximizes a margin corresponding to the distance between a first boundary line 110 passing through support vectors of class 1 and a second boundary line 120 passing through support vectors of class 2.

The SVM algorithm may be used to linearly classify a data set belonging to either of two classes. These SVM algorithms are classified into hard-margin SVM algorithm and soft-margin SVM algorithm depending on whether an outlier is allowed. Hereinafter, the hard-margin SVM algorithm and the soft-margin SVM algorithm will be briefly described with reference to FIGS. 1B and 1C.

The hard-margin SVM algorithm is an SVM algorithm that does not allow an outlier, and is a classifier that finds a hyperplane having a maximum margin. A hyperplane 131 of the hard-margin SVM may be defined as equation 1 below, a first boundary line 111 passing through the support vector of class 1 may be defined as equation 2 below, and a second boundary line 121 passing through the support vector of class 2 may be defined as equation 3 below.

$${w}^{T} x + b = 0 \qquad [ Equation 1 ]$$

$${w}^{T} x + b = - 1 \qquad [ Equation 2 ]$$

$${w}^{T} x + b = 1 \qquad [ Equation 3 ]$$

Here, w is a normal vector of a hyperplane, x is a data set, and b is a bias of the hyperplane.

A data set existing under the first boundary line 111 passing through the support vector of class 1 may be defined as equation 4 below, and a data set existing above the second boundary line 121 passing through the support vector of class 2 may be defined as equation 5 below. In addition, a margin (m) corresponding to the distance between the first boundary line 111 and the second boundary line 121 may be defined as equation 6 below.

$$< w , {x}_{i} > + b \geq 1 : ∀ {y}_{i} = 1 \qquad [ Equation 4 ]$$

$$< w , {x}_{i} > + b \leq - 1 : ∀ {y}_{i} = - 1 \qquad [ Equation 5 ]$$

$$m = \frac{2}{‖ w ‖} \qquad [ Equation 6 ]$$

Hard-margin SVM is an algorithm of selecting the optimal hyperplane 131 having the maximum margin, that is, the values of w and b. Here, since maximizing the margin is the same as minimizing the reciprocal of the margin, the optimization problem for selecting the optimal hyperplane may be defined as equation 7 below. In the below equation 7, the mathematical expression in the preceding part corresponds to the objective function, and the mathematical expression in the following part corresponds to constraints.

$${p}^{*} = * {min}_{w , b} \frac{1}{2} {‖ w ‖}^{2} : {y}_{i} ( < w , {x}_{i} > + b ) \geq 1 ∀ i \qquad [ Equation 7 ]$$

Equation 7 above corresponds to a quadratic optimization problem, as a primal problem, among optimization problems. Therefore, it is much more convenient to solve a dual problem using a Lagrange function rather than directly solving a primal problem. This is due to the fact that the solution of the primal problem and the solution of the dual problem are identical when the Karush-Kuhn-Tucker (KKK) condition is satisfied.

A Lagrange function for deriving the dual problem may be defined as equation 8 below.

$$L ( w , b , α ) = \frac{1}{2} {‖ w ‖}^{2} - {{\sum }^{N}}_{i = 1} {α}_{i} [ {y}_{i} ( < w , {x}_{i} > + b ) - 1 ] \qquad [ Equation 8 ]$$

Here, w is a normal vector of the hyperplane, xᵢ is i-th data, b is a bias of the hyperplane, and α is a Lagrange multiplier or weight. Hereinafter, in this embodiment, for convenience of explanation, variable a is referred to as a “weight”.

Equation 9 below may be obtained by performing partial differentiation of Equation 8 above by variable w, Equation 10 below may be obtained by performing partial differentiation of Equation 8 above by variable b, and a dual problem such as Equation 11 below may be derived by substituting the results of equations 9 and 10 into equation 7 above.

$$\frac{\partial L}{\partial w} ( {w}^{*} , {b}^{*} , {α}^{*} ) = 0 ⇔ {w}^{*} = {\sum }_{i = 1}^{N} {α}_{i}^{*} {y}_{i} {x}_{i} \qquad [ Equation 9 ]$$

$$\frac{\partial L}{\partial b} ( {w}^{*} , {b}^{*} , {α}^{*} ) = 0 ⇔ {\sum }_{i = 1}^{N} {α}_{i}^{*} {y}_{i} = 0 \qquad [ Equation 10 ]$$

$${d}^{*} = {max}_{α \geq 0} {min}_{w , b} L ( w , b , α ) = {max}_{α \geq 0} {\sum }_{i = 1}^{N} {α}_{i} - \frac{1}{2} {\sum }_{i , j = 1}^{N} {α}_{i} {a}_{j} {y}_{i} {y}_{j} < {x}_{i} , {x}_{j} > : {\sum }_{i = 1}^{N} {α}_{i} {y}_{i} = 0 \qquad [ Equation 11 ]$$

As shown in Equation 11 above, the dual problem may be organized as a function regarding α, and the value of w of the hyperplane having the maximum margin may be calculated by calculating the optimal value of α that satisfies the function. In addition, the value of b of the hyperplane having the maximum margin may be calculated through Equation 12 below.

$${b}^{*} = {y}_{k} - {\sum }_{i = 1}^{N} {α}_{i}^{*} {y}_{i} < {x}_{i} , {x}_{k} > ∀ k : {α}_{k}^{*} > 0 \qquad [ Equation 12 ]$$

Here, xᵢ is i-th data, xₖ is k-th data, yᵢ is a class of i-th data, yₖ is a class of k-th data, αᵢ* is a weight of i-th data, and αₖ* is a weight of k-th data.

When the optimal hyperplane 131 is determined through the above process, binary classification of test data (i.e., input data) may be performed by determining whether the test data exists above or below with reference to the hyperplane. A classification formula for the test data may be defined as equation 13 below. In Equation 13 below, an argument of a sine function is referred to as a classification score.

$$\tilde{y} = sin \{ {\sum }_{i = 1}^{N} {α}_{i}^{*} {y}_{i} < {x}_{i} , \tilde{x} > + {b}^{*} \} \qquad [ Equation 13 ]$$

On the other hand, the soft-margin SVM algorithm is fundamentally based on the hard-margin SVM algorithm, but differs from the hard-margin SVM algorithm in that a slight slack variable (ξ) is placed on the boundaries 112 and 122 where the support vectors are located. Therefore, the primal problem of the soft-margin SVM algorithm may be defined as equation 14 below. Here, the mathematical expression in the preceding part corresponds to the objective function, and the mathematical expression in the following part corresponds to constraints.

$${p}^{*} = \begin{matrix}min \\ w , b , ξ\end{matrix} \frac{1}{2} {‖ w ‖}^{2} + \frac{C}{2} {\sum }_{i = 0}^{M - 1} {ξ}^{2} : {y}_{i} ( < w , Φ ( {x}_{i} ) > + b ) \geq 1 - {ξ}_{i} \qquad [ Equation 14 ]$$

Here, w is the normal vector of the hyperplane, xᵢ is the i-th data, b is a bias of the hyperplane, C is a hyperparameter for controlling overfitting and underfitting, and ξ is a slack variable.

Equation 14 corresponds to a quadratic optimization problem, as a primal problem, among optimization problems. Therefore, it is much more convenient to solve a dual problem using a Lagrange function rather than directly solving a primal problem. The dual problem using the Lagrange function may be defined as equation 15 below.

$${d}^{*} = \begin{matrix}max \\ a \geq 0 , μ \geq 0\end{matrix} \begin{matrix}min \\ w , b , ξ\end{matrix} L ( w , b , ξ , α , μ ) = \begin{matrix}max \\ α \geq 0\end{matrix} {\sum }_{i = 0}^{M - 1} {α}_{i} - \frac{1}{2} {\sum }_{i , j = 0}^{M - 1} {α}_{i} {α}_{j} {y}_{i} {y}_{j} < {x}_{i} , \text{} {x}_{j} > - \frac{1}{2 C} {\sum }_{i = 0}^{M - 1} {α}_{i}^{2} : {\sum }_{i = 0}^{M - 1} {α}_{i} {y}_{i} = 0 \qquad [ Equation 15 ]$$

As shown in Equation 15 above, the dual problem may be organized as a function regarding α, and the value of w of the hyperplane having the maximum margin may be calculated by calculating the optimal value of α that satisfies the function. In addition, the value of b of the hyperplane having the maximum margin may be calculated through Equation 16 below.

$${b}^{*} = {y}_{q} ( 1 - {C}^{- 1} {α}_{q} ) - {\sum }_{i = 0}^{M - 1} {α}_{i}^{*} {y}_{i} < {x}_{i} , {x}_{q} > \qquad [ Equation 16 ]$$

Here, xᵢ is i-th data, x_{q} is q-th data, yᵢ is a class of the i-th data, y_{q} is a class of the q-th data, and αᵢ* is a weight of the i-th data.

When an optimal hyperplane 132 is determined through the above process, binary classification of the test data may be performed by determining whether the test data exists above or below with reference to the hyperplane. A classification formula for the test data may be defined as equation 13 described above.

The SVM algorithm may be used not only for linear classification, but also for non-linear classification. The SVM algorithm used for non-linear classification is called a kernel SVM algorithm.

In order for the SVM algorithm to be used for non-linear classification, a mapping process of converting given data into data in a high-dimensional feature space is required. That is, as shown in FIG. 1D, a mapping process of converting data existing in an input space into data existing in a feature space may be performed. Through the mapping process, non-linear classification in the input space may be switched to linear classification in the feature space. In this case, if data existing in the input space is x, data existing in the feature space may be represented as φ(x).

The kernel SVM algorithm requires complex computation due to high-dimensional mapping, and uses kernel tricks using a kernel function to efficiently perform the computation. The principle of the kernel trick is to use mathematical tricks, and if the inner product in the feature space can be calculated, there is no need to calculate data mapping.

In the kernel SVM algorithm, the dual problem using the Lagrange function may be defined as equation 17 below, and the classification equation for the test data may be defined as equation 18 below.

$${d}^{*} = \begin{matrix}max \\ α \geq 0\end{matrix} {\sum }_{i = 0}^{M - 1} {α}_{i} - \frac{1}{2} {\sum }_{i , j = 0}^{M - 1} {α}_{i} {α}_{j} {y}_{i} {y}_{j} < Φ ( {x}_{i} ) , \text{} Φ ( {x}_{j} ) > - \frac{1}{2 C} {\sum }_{i = 0}^{M - 1} {α}_{i}^{2} : {\sum }_{i = 0}^{M - 1} {α}_{i} {y}_{i} = 0 \qquad [ Equation 17 ]$$

$$\tilde{y} = sin \{ {\sum }_{i = 0}^{M - 1} {α}_{i}^{*} {y}_{i} < Φ ( {x}_{i} ) , Φ ( \tilde{x} ) > + {b}^{*} \} \qquad [ Equation 18 ]$$

Here, φ(·) is data existing in the feature space.

When the kernel function is applied to equations 17 and 18 above, the dual problem of the algorithm may be defined as equation 19 below, and the classification equation may be defined as equation 20 below.

$${d}^{*} = \begin{matrix}max \\ α \geq 0\end{matrix} {\sum }_{i = 0}^{M - 1} {α}_{i} - \frac{1}{2} {\sum }_{i , j = 0}^{M - 1} {α}_{i} {α}_{j} {y}_{i} {y}_{j} k ( {x}_{i} , {x}_{j} ) - \frac{1}{2 C} {\sum }_{i = 0}^{M - 1} {α}_{i}^{2} : {\sum }_{i = 0}^{M - 1} {α}_{i} {y}_{i} = 0 \qquad [ Equation 19 ]$$

$$\tilde{y} = sin \{ {\sum }_{i = 0}^{M - 1} {α}_{i}^{*} {y}_{i} k ( {x}_{i} , \tilde{x} ) + {b}^{*} \} \qquad [ Equation 20 ]$$

Here, k(xᵢ, xⱼ) is a kernel function.

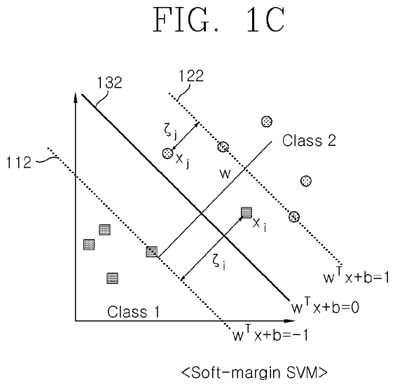

FIG. 2 illustrates the structure of a swap test classifier (STC) related to the disclosure.

Referring to FIG. 2, a swap test classifier 200 related to the disclosure is a device for classifying data by performing a swap test on ancilla qubits and level qubits in an input state, as one of the quantum binary classification algorithms.

The swap test classifier 200 may include first to fifth registers (not shown), an input state generation unit 210, and a binary classification unit 220.

The first register is a device for storing ancilla qubits, the second register is a device for storing n copies of test data (\tilde{x}), the third register is a device for storing data qubits, the fourth register is a device for storing level qubits, and the fifth register is a device for storing index qubits.

The input state generation unit 210 may perform a function of converting classical data into data of a quantum state by using amplitude encoding. For example, as defined in Equation 21 below, one classical data may be represented as data in a quantum state through amplitude encoding. N data dimensions may be represented as log₂ N qubits through the corresponding equation.

$$\vert {x}_{j} ≻ := \frac{1}{‖ {x}_{j} ‖} {\sum }_{i = 1}^{N} {x}_{ij} \vert i ≻ \qquad [ Equation 21 ]$$

Here,

$${x}_{j} = {( {x}_{ij} , ... , {x}_{Nj} )}^{T}$$

The input state generation unit 210 may perform a function of generating an input state required for a classification protocol. To this end, the input state generation unit 210 may include an encoding block (Uₛ(D)) configured by one or more quantum gates.

As an example, an input state generated through the encoding block (Uₛ(D)) may be defined as equation 22 below.

$$\vert Ψ {≻}_{in} = \vert 0 ≻ ⊗ {\sum }_{j = 1}^{M} ( \sqrt{{α}_{j}} \vert j ≻ ⊗ \vert {x}_{j} ≻ ⊗ \vert {y}_{j} ≻ ⊗ \vert \tilde{x} ≻ ) \qquad [ Equation 22 ]$$

Here, αⱼ is the probability amplitude of the quantum state.

The binary classification unit 220 may perform binary classification by performing a swap test on qubits in an input state. The binary classification unit 220 may include two Hadamard gates and n controlled SWAP gates.

The result of measuring two qubits observable in the auxiliary qubit and the level qubit of the quantum circuit 200 may be defined as equation 23 below. The corresponding equation corresponds to the classification score of the swap test classifier 200. The kernel function in the equation is configured as

$$k ( {x}_{j} , \tilde{x} ) = {\vert < x \vert \tilde{x} > \vert}^{2} ,$$

and thus the equation may be used for binary classification.

$$< {Z}_{a} {Z}_{y} >= {\sum }_{j = 1}^{N} {{α}_{j} ( - 1 )}^{{y}_{j}} {\vert < x \vert \tilde{x} > \vert}^{2} \qquad [ Equation 23 ]$$

Here, Z is a single qubit Pauli operator σ_{z}, and the subscripts a and y indicate a state in which the corresponding operator is in an operating state for each of the auxiliary qubit and the level qubit.

The swap test classifier 200 suffers from poor classification performance compared to the existing quantum support vector machine (QSVM) because the swap test classifier uses all the data having some fixed weight factors, without the need to perform an optimization process for the parameter αⱼ. On the other hand, since the quantum support vector machine (QSVM) relies on comprehensive subroutines such as density matrix exponential and quantum matrix inversion, there is a problem that the QSVM is unable to be run on NISQ computers expected to be available in the near future.

The disclosure proposed to solve these problems provides an optimization protocol for the parameters (α, b) while maintaining feasibility on the NISQ computer by using a hybrid quantum-classical algorithm obtained by combining classical and quantum algorithms. That is, the basic idea of the disclosure is to calculate an objective function and a classification score of the optimization problem on a quantum computer, and update the parameters of the objective function by using a heuristic optimization technique on a classical computer. Here, the heuristic optimization technique may use a simultaneous perturbation stochastic approximation (SPSA) optimizer as a classical optimization technique used in variational quantum algorithms (VQA), and is not necessarily limited thereto.

On the other hand, the classical SVM algorithm performs binary classification by solving a constrained optimization problem existing in a primal or dual form. Heuristic optimization may be used to achieve convex optimization and bypass quantum subroutines to find the global optima. The heuristic optimization may be performed through a parameterized quantum circuit. However, heuristic optimization requires non-constrained optimization problems. That is, in order to calculate an optimization problem by using a quantum circuit, a constrained optimization problem is required to be converted into a non-constrained optimization problem. In addition, the quantum algorithm requires a normalization condition of the quantum state, that is,

$${\sum }_{j}^{M - 1} {α}_{j} = 1.$$

According to the requirements of these quantum algorithms, the classical SVM algorithm needs to be converted to remove constraints of the optimization problem. The main idea of the conversion is based on the fact that under the conversion

$$( {k}_{ij} \to {k}_{ij} + \frac{1}{λ} )$$

for positive hyperparameter λ, the PSD kernel function (kᵢⱼ=k(xᵢ, xⱼ)) remains to be positive semi-definite (PSD), and eventually the following conversion, i.e.,

$$Φ ( x ) \to [ Φ ( x ) , \frac{1}{\sqrt{λ}} ] , w \to [ w , \sqrt{k} b ]$$

is allowed. As a result, the dual problem defined by Equation 19 above may be reorganized as shown in Equation 24 below without equality constraints.

$${d}^{*} = {max}_{α \geq 0} {\sum }_{i = 0}^{M - 1} {α}_{i} - \frac{1}{2} {\sum }_{i , j = 0}^{M - 1} {α}_{i} {α}_{j} {y}_{i} {y}_{j} {k}_{λ} ( {x}_{i} , {x}_{j} ) - \frac{1}{2 C} {\sum }_{i = 0}^{M - 1} {α}_{i}^{2} \qquad [ Equation 24 ]$$

Here, a new kernel function is

$${k}_{λ} ( x , y ) = k ( x , y ) + \frac{1}{λ} .$$

Under KKT condition, the optimal bias (b*)) to determine the hyperplane having the maximum margin may be defined as equation 25 below.

$${b}^{*} = {λ}^{- 1} {{\sum }_{i = 0}}^{M - 1} {α}_{i}^{*} {y}_{i} \qquad [ Equation 25 ]$$

A primal problem corresponding to the dual problem may be defined as equation 26 below.

$${p}^{*} = {min}_{w , b , ξ} \frac{k}{2} {‖ w ‖}^{2} + \frac{λ}{2} {b}^{2} + \frac{C}{2} {\sum }_{i = 0}^{M - 1} {ξ}^{2} : {y}_{i} ( < w , Φ ( {x}_{i} ) > + b ) \geq 1 - {ξ}_{i} \qquad [ Equation 26 ]$$

When the optimal hyperplane is determined through the above-described process, binary classification of test data may be performed by determining whether the test data exists above or below with reference to the hyperplane. A classification formula for the test data may be defined as equation 27 below.

$$\tilde{y} = sin \{ {\sum }_{i = 0}^{M - 1} {α}_{i}^{*} {y}_{i} k ( {x}_{i} , \tilde{x} ) \} \qquad [ Equation 27 ]$$

The SVM algorithm converted to a reduced form as such has two main advantages. The first advantage is that a bias term can be derived from the KKT condition, thereby removing the ambiguity of method of obtaining the bias. The second advantage is that there is no equality constraint in the dual problem. The SVM algorithm converted to the reduced form may be used to derive a quantum approximate support vector machine (QASVM) according to the disclosure.

The quantum approximate support vector machine (QASVM) algorithm according to the disclosure is a hybrid quantum-classical algorithm that performs binary classification by approximating the optimization problem of a support vector machine for NISQ applications. Here, the reason for approximating the optimization problem of the support vector machine is to use a quantum circuit.

The process of approximating the optimization problem of the support vector machine may include a process of converting the above-described constrained optimization problem to a non-constrained optimization problem, and a process of approximating an objective function of the support vector machine, which will be described later.

The QASVM algorithm is a hybrid quantum-classical algorithm that combines classical and quantum algorithms, and the quantum part of the algorithm may efficiently calculate the objective function of a support vector machine, and the classical part may update the parameters of the objective function through heuristic optimization.

The QASVM algorithm is a hybrid quantum-classical algorithm that performs binary classification by approximating the optimization problem of a support vector machine (SVM). Here, the support vector machine (SVM) includes hard-margin SVM and soft-margin SVM.

The QASVM algorithm may approximate the constrained optimization problem of the support vector machine to a non-constrained optimization problem. In other words, the QASVM algorithm may acquire the dual problem (d*) of the SVM algorithm converted to the above-mentioned reduced form.

The QASVM algorithm may convert the dual problem (d*) of the SVM algorithm converted to the reduced form, by using the normalization condition of the quantum state, i.e.,

$${{\sum }_{j}}^{M - 1} {α}_{i}^{2} = 1.$$

That is, the QASVM algorithm may convert the above-described Equation 24 into Equation 28 below.

$${d}^{**} = {min}_{α ∈ PV} {\sum }_{i , j = 0}^{M - 1} {α}_{i} {α}_{j} {y}_{i} {y}_{j} {k}_{λ} ( {x}_{i} , {x}_{j} ) + \frac{1}{C} {{\sum }_{i = 0}}^{M - 1} {α}_{i}^{2} \qquad [ Equation 28 ]$$

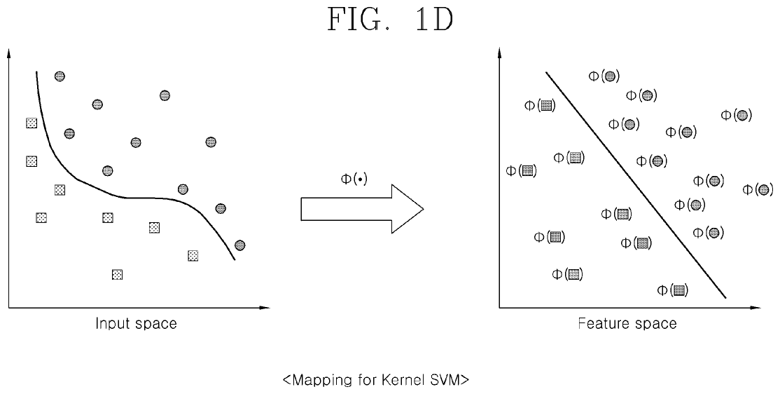

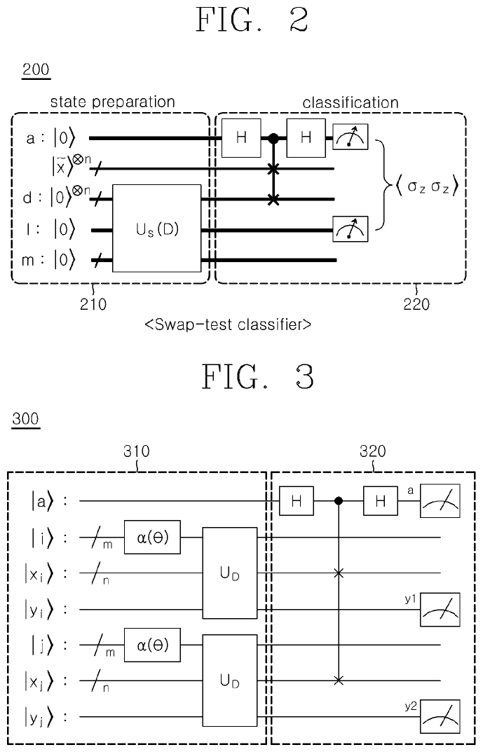

The QASVM algorithm may solve the above-described dual problem (d**) by using a predetermined quantum circuit. Here, the first term of the dual problem (d**) may be calculated through a first quantum circuit (i.e., a loss circuit, 300) shown in FIG. 3, and the second term of the dual problem (d**) may be calculated through a second quantum circuit (i.e., a normalization circuit, 400) shown in FIG. 4.

The first quantum circuit 300 may include first to seventh registers (not shown), an input state generation unit 310, and an objective function calculation unit 320.

The input state generation unit 310 may perform a function of converting classical data into data of a quantum state by using amplitude encoding or the like. In addition, the input state generation unit 310 may perform a function of generating an input state necessary for calculating an objective function.

For example, the input state generation unit 310 may include two weight blocks (α(θ)) and two encoding blocks (U_{d}). The weight blocks (α(θ) and encoding blocks (U_{d}) are a kind of hardware block, and may be configured by one or more quantum gates. The input state generated through the weight blocks (α(θ) and encoding blocks (U_{d}) may be defined as equation 29 below.

$$\vert Ψ {≻}_{d} = \vert 0 ≻ {\sum }_{i = 1}^{N} ( \sqrt{{α}_{i}} \vert i ≻ \vert {x}_{ι} ≻ \vert {y}_{i} ≻ ) {\sum }_{j = 1}^{N} ( \sqrt{{α}_{j}} \vert j ≻ \vert {x}_{j} ≻ \vert {y}_{j} ≻ ) \qquad [ Equation 29 ]$$

Here, Kronecker multiplication symbol ⊗ is omitted.

The objective function calculation unit 320 may perform a swap test on the qubits in the input state to perform the function of calculating the objective function of the QASVM algorithm, that is, the first term of the dual problem (d**).

For example, the objective function calculation unit 320 may include two Hadamard gates and n controlled SWAP gates.

The result of measuring 3-qubits observable in the first qubit, the fourth qubit, and the seventh qubit of the first quantum circuit 300 may be defined as equation 30 below. In addition, the result of measuring 2-qubits observable in the fourth qubit and the seventh qubit of the first quantum circuit 300 may be defined as equation 31 below.

$$< {Z}_{a} {Z}_{y 1} {Z}_{y 2} > = \sum {α}_{i} {y}_{i} {α}_{j} {y}_{j} {\vert < {x}_{i} \vert {x}_{j} > \vert}^{2} \qquad [ Equation 30 ]$$

$$< {Z}_{y 1} {Z}_{y 2} > = {( {\sum }_{i = 0}^{M - 1} {α}_{i} {y}_{i} )}^{2} \qquad [ Equation 31 ]$$

Here, measurement of Z operator may be performed on the first qubit, the fourth qubit, and the seventh qubit.

The second quantum circuit 400 may include first and second registers (not shown), an input state generation unit 410, and an objective function calculation unit 420.

The input state generation unit 410 may perform a function of generating an input state necessary for calculating an objective function. For example, the input state generation unit 410 may include two weight blocks (α(θ)). The weight blocks (α(θ)) are a kind of hardware block, and may be configured by one or more quantum gates.

The objective function calculation unit 420 may perform a controlled-not (CNOT) operation on the qubits in the input state so as to perform a function of calculating the second term of the dual problem (d**). For example, the objective function calculation unit 420 may include m CNOT gates.

The result of measuring the observable 1-qubit in the second qubit of the second quantum circuit 400 may be defined as equation 32 below.

$$Prob [ 00 … 0 ] = {\sum }_{i = 0}^{M - 1} {α}_{i}^{2} \qquad [ Equation 32 ]$$

The objective function (d**) of the QASVM algorithm is obtained by summing equations 30, 31 and 32 above. That is, the objective function (d**) of the QASVM algorithm is obtained by

$$< {Z}_{a} {Z}_{y 1} {Z}_{y 2} > + \frac{1}{λ} < {Z}_{y 1} {Z}_{y 2} > + \frac{1}{C} Prob [ 00 … 0 ] .$$

The time cost to calculate the objective function of the QASVM algorithm is O(1), which represents a significant speed-up compared to classical SVM algorithms.

The QASVM algorithm may repeat the calculation of the objective function followed by the update of the parameters a until the objective function converges to a predetermined value (i.e., until the objective function is minimized). The set of parameters a is determined by the parameter θ of an unitary operation of encoding the weight vector into a probability amplitude. Optimum weight information may be obtained through this optimization procedure, and the obtained weight information may be used to calculate a classification score of the corresponding algorithm.

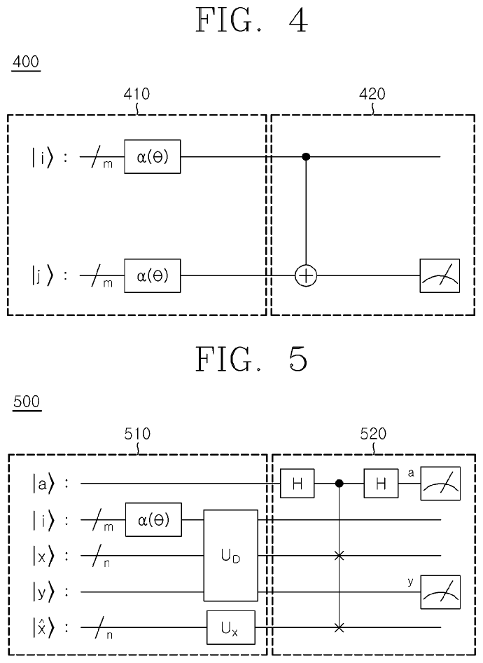

Thereafter, the QASVM algorithm may calculate the above-described classification score (i.e., Equation 27) by using a predetermined quantum circuit. Here, the quantum circuit may be implemented through a quantum circuit 500 shown in FIG. 5. The quantum circuit 500 may include first to fifth registers (not shown), an input state generation unit 510, and a binary classification unit 520.

The input state generation unit 510 may perform a function of converting classical data into data in a quantum state by using amplitude encoding. In addition, the input state generation unit 510 may perform a function of generating an input state necessary for a classification protocol.

For example, the input state generation unit 510 may include a weight block (α(θ)), a first encoding block (U_{d}), and a second encoding block (Uₓ). The weight block (α(θ)) and encoding blocks (U_{d} and Uₓ)) are a kind of hardware block, and may be configured by one or more quantum gates. The input state generated through the weight block (α(θ)) and encoding blocks (U_{d} and Uₓ) may be defined as equation 19 described above.

The binary classification unit 520 may perform binary classification by performing a swap test on qubits in an input state. The binary classification unit 520 may include two Hadamard gates and n controlled SWAP gates.

The result of measuring 2-qubits observable in the first qubit and the fourth qubit of the quantum circuit 500 may be defined as equation 33 below. Further, the result of measuring the single qubit observable in the first qubit of the quantum circuit 500 may be defined as equation 34 below.

$$< {Z}_{a} {Z}_{y} >= \sum {α}_{i} {y}_{i} {\vert < {x}_{i} \vert \tilde{x} > \vert}^{2} \qquad [ Equation 33 ]$$

$$< {Z}_{y} > = {{\sum }_{i = 0}}^{M - 1} {α}_{i} {y}_{i} \qquad [ Equation 34 ]$$

The classification score of the QASVM algorithm is obtained by summing equations 33 and 34 above. That is, the classification score of the QASVM algorithm is obtained by

$$< {Z}_{a} {Z}_{y} > + \frac{1}{λ} < {Z}_{y} > .$$

Accordingly, the classification formula of the QASVM algorithm is to be

$$sin ( < {Z}_{a} {Z}_{y} > + \frac{1}{λ} < {Z}_{y} > ) ,$$

and data is binary classified using the corresponding classification formula.

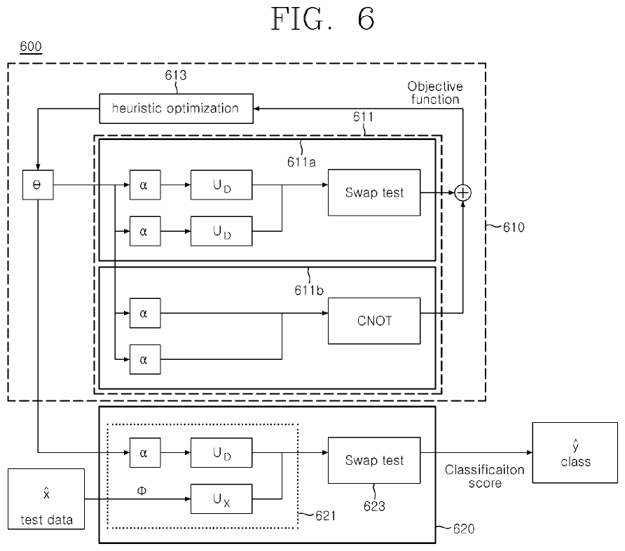

FIG. 6 illustrates a configuration of a data classification apparatus according to an embodiment of the disclosure. That is, FIG. 6 illustrates a configuration of a data classification apparatus using the QASVM algorithm.

Referring to FIG. 6, a data classification device 600 according to an embodiment of the disclosure may include a weight calculation unit 610 and a data classification unit 620.

The weight calculation unit 610 may perform a function of calculating the optimal weight a that minimizes the objective function of the QASVM algorithm. At this time, the weight calculation unit 610 may calculate the optimal weight a by using variational quantum algorithms (VQA).

The weight calculation unit 610 may include an objective function calculation unit 611 driven on a quantum computer and a parameter update unit 613 driven on a classical computer.

The objective function calculation unit 611 may perform a function of calculating an objective function of the QASVM algorithm by using predetermined first and second quantum circuits. The objective function calculation unit 611 may be implemented through the above-described quantum circuit 300 of FIG. 3 and the above-described quantum circuit 400 of FIG. 4.

For example, the objective function calculation unit 611 may include a first quantum circuit 611a for calculating the first term existing in the objective function (d**) of the QASVM algorithm and a second quantum circuit 611b for calculating the second term existing in the corresponding objective function (d**).

The parameter update unit 613 may perform a function of updating the parameters (α) of the objective function by using a heuristic optimization technique on a classical computer. As the heuristic optimization technique, an SPSA optimizer may be used, but is not necessarily limited thereto.

The process of calculating the objective function of the QASVM algorithm through the objective function calculation unit 611 and the process of updating the parameters (α) of the corresponding objective function through the parameter update unit 613 may be repeatedly performed until the objective function of the QASVM algorithm is minimized. Through this iterative process, the weight calculation unit 610 may calculate optimal weight information for minimizing the objective function of the QASVM algorithm, and may provide the calculated weight information to the data classification unit 620.

The data classification unit 620 may perform a function of binary classification of test data, based on the optimal weight information received from the weight calculation unit 610.

The data classification unit 620 may calculate a classification score of the QASVM algorithm by using a predetermined quantum circuit, and may binary classify the test data based on the calculated classification score. The data classification unit 620 may be implemented through the quantum circuit 500 of FIG. 5 described above.

For example, the data classifier 620 may include an input state generation unit 621 configured by one weight block and two encoding blocks, and a binary classification unit 623 configured by two Hadamard gates and n controlled SWAP gates.

As described above, a data classification apparatus according to an embodiment of the disclosure can effectively perform a data classification function that is feasible on a NISQ computer and has excellent classification performance, by using the QASVM algorithm which approximates the optimization problem of a support vector machine (SVM) algorithm.

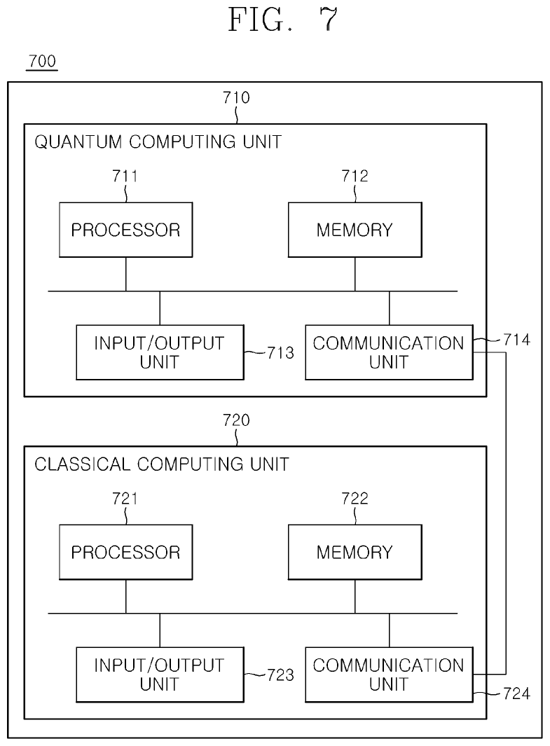

FIG. 7 is a configuration block diagram of a computing device according to an embodiment of the disclosure.

Referring to FIG. 7, a computing device 700 according to an embodiment of the disclosure may include a quantum computing unit 710 and a classical computing unit 720. The computing device 700 may be the above-described data classification device 600 or one or more components included in the data classification device 600.

The quantum computing operation of the data classification device 600 may be performed by the quantum computing unit 710, and the classical computing operation of the data classification device 600 may be performed by the classical computing unit 720.

The quantum computing unit 710 may include at least one processor 711, a memory 712, an input/output unit 713, and a communication unit 714. The classical computing unit 720 may also include at least one processor 721, a memory 722, an input/output unit 723, and a communication unit 724.

The processors 711 and 721 may cause the computing device 700 to operate according to the above-mentioned exemplary embodiments. For example, the processors 711 and 721 may execute one or more programs stored in the memories 712 and 722. The one or more programs may include one or more computer-executable instructions which, when executed by the processors 711 and 721, cause the computing device 700 to perform operations according to exemplary embodiments.

The memories 712 and 722 are configured to store computer-executable instructions or program codes, program data, and/or other suitable forms of information. Programs stored in the memories 712 and 722 include a set of instructions executable by the processors 711 and 721. In this embodiment, the memories 712 and 722 may be volatile memories such as random access memories, non-volatile memories, or suitable combinations thereof.

The input/output units 713 and 723 may provide an input interface for connection with an input device (not shown). In addition, the input/output units 713 and 723 may provide an output interface for connection with an output device (not shown).

The communication units 714 and 724 may provide a wired/wireless communication interface for transmitting and receiving data.

The above-described disclosure can be implemented as computer-readable code on a medium on which a program is recorded. The computer-readable medium includes all types of recording devices in which data that can be read by a computer system is stored. Examples of computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Accordingly, the above detailed description should not be construed in all aspects as limiting, and be considered illustrative. The scope of the disclosure should be determined by reasonable interpretation of the appended claims, and all changes within the equivalent scope of the disclosure are included in the scope of the disclosure.

1. A data classification apparatus feasible on a quantum computer, such as a noise intermediate scale quantum (NISQ) computer, the apparatus comprising:
a weight calculation unit configured to calculate weight information for minimizing an objective function of a quantum approximate support vector machine (QASVM) algorithm; and
a data classification unit configured to calculate a classification score of the QASVM algorithm using the weight information obtained from the weight calculation unit, and classify a class of input data based on the calculated classification score.

2. The apparatus of claim 1, wherein the QASVM algorithm is an algorithm that approximates an optimization problem of a support vector machine (SVM) algorithm.

3. The apparatus of claim 1, wherein an objective function (d**) of the QASVM algorithm is defined by a mathematical expression,
$${d}^{**} = {min}_{α ∈ PV} {\sum }_{i , j = 0}^{M - 1} {α}_{i} {α}_{j} {y}_{i} {y}_{j} {k}_{λ} ( {x}_{i} , {x}_{j} ) + \frac{1}{C} {{\sum }_{i = 0}}^{M - 1} {α}_{i}^{2} ,$$
where x is data, y is a class of data, α is a weight of data, C is a hyperparameter, and k₈₀ ( ) is a kernel function.

4. The apparatus of claim 1, wherein the weight calculation unit is configured to calculate the weight information by using variational quantum algorithms (VQA).

5. The apparatus of claim 1, wherein the weight calculation unit comprises an objective function calculation unit configured to calculate an objective function of the QASVM algorithm, and a parameter update unit configured to update parameters of the objective function.

6. The apparatus of claim 5, wherein the objective function calculation unit comprises a first quantum circuit configured to calculate a first part of the objective function of the QASVM algorithm, and a second quantum circuit configured to calculate a second part of the objective function of the QASVM algorithm.

7. The apparatus of claim 6, wherein the first quantum circuit comprises an input state generation unit configured to convert classical data into data in a quantum state by using amplitude encoding, and an objective function calculation unit configured to calculate the first part of the objective function by performing a swap test on qubits of an input state.

8. The apparatus of claim 6, wherein the second quantum circuit comprises an input state generation unit configured to convert classical data into data in a quantum state by using amplitude encoding, and an objective function calculation unit configured to calculate the second part of the objective function by performing a CNOT operation on qubits of the input state.

9. The apparatus of claim 5, wherein the parameter update unit is configured to update the parameters of the objective function by using a classical heuristic optimization technique.

10. The apparatus of claim 1, wherein the data classification unit is configured to calculate a classification score of the QASVM algorithm by using a predetermined quantum circuit.

11. The apparatus of claim 1, wherein the data classification unit comprises an input state generation unit configured to generate an input state required for a classification protocol, and a binary classification unit configured to perform binary classification by performing a swap test on qubits of an input state.

12. A data classification method feasible on a noise intermediate scale quantum (NISQ) computer, the method comprising:
calculating weight information for minimizing an objective function of a quantum approximate support vector machine (QASVM) algorithm;
calculating a classification score of the QASVM algorithm using the calculated weight information; and
classifying a class of input data based on the calculated classification score.

13. The apparatus of claim 4, the VQA comprises of a parameterized quantum circuit controlled with an optimizer algorithm.
